(19) United States
(12) Patent Application Publication
(10) Pub. No.: US 2025/0369521 A1
(43) Pub. Date: Dec. 4, 2025

(54) VALVE BODY FOR A DIAPHRAGM VALVE, AND DIAPHRAGM VALVE

(71) Applicant: GEMÜ Gebr. Müller Apparatebau GmbH & Co. Kommanditgesellschaft, Ingelfingen (DE)

(72) Inventors: Klaus Frankenbach, Forchtenberg (DE); Maximilian Renner, Osterburken (DE); Tobias Tschernowsky, Ingelfingen (DE)

(21) Appl. No.: 19/223,648

(22) Filed: May 30, 2025

(30) Foreign Application Priority Data
Jun. 3, 2024 (DE) 10 2024 115 315.6

(51) Int. Cl. F16K 7/12

(52) U.S. Cl. CPC F16K 7/126

(57) ABSTRACT

A valve body for a diaphragm valve includes at least one process fluid channel, a valve seat accessible via an opening, and a recess arranged between the opening and the fluid channel. The recess and valve chamber geometry are configured to improve flow efficiency by reducing flow separation and pressure drop. In some examples, the valve seat includes a faceted seating surface, and obtuse angular relationships between central longitudinal axes define flow-favorable contours. The recess has a central portion with reduced curvature and increased effective width to enhance flow uniformity. Faceted transitions between the valve seat and adjacent surfaces further improve the kV value. The valve body may be symmetrical about the valve seat and is optionally made of a metal alloy. A diaphragm valve including the valve body, a diaphragm, a drive rod, and a drive mechanism is also disclosed.

### TECHNICAL FIELD

This disclosure relates to advances in the field of diaphragm valve technology, and more particularly, to valve bodies with improved flow geometry.

### BACKGROUND

Diaphragm valves are widely used to control fluid flow in applications where cleanliness, flow precision, or corrosion resistance are impactful. For instance, such applications include semiconductor manufacturing, pharmaceuticals, and food processing. The geometry of the fluid-conducting region within the valve body significantly affects flow behavior. Conventional valve bodies often include abrupt transitions, sharp corners, or stagnant regions, leading to turbulence, particle deposition, increased pressure drop, and frequent maintenance.

### SUMMARY

Existing diaphragm valves often exhibit undesirable flow characteristics due to suboptimal internal geometries such as sharp transitions, abrupt changes in flow direction, and flow-dead zones. These conditions can result in flow separation, turbulence, increased pressure drop, and the entrapment of particles, which are particularly problematic in high-purity or high-throughput systems. Such inefficiencies lead to reduced performance, more frequent maintenance, and operational unreliability.

The present disclosure addresses this technical problem by introducing a diaphragm valve body with optimized internal flow geometry. The key innovations include a strategically angled recess between the process fluid channel and the valve seat, angular alignment of the valve chamber axes, and faceted transitions at interface regions such as between the valve chamber and the valve seat. These geometric features collectively reduce flow resistance, minimize flow separation, and maintain sealing surface integrity. The resulting diaphragm valve exhibits enhanced kV values, improved flow uniformity, and lower energy loss, making it particularly effective for demanding fluid control environments.

A first aspect of the description relates to a valve body for a diaphragm valve, the valve body comprising: at least one process fluid channel, which extends along an imaginary first central longitudinal axis; at least one valve seat, which is accessible via an opening in the valve body that can be closed by a valve diaphragm; and at least one recess arranged between the opening and the process fluid channel.

The recess improves the kV value of the valve body and the diaphragm valve as a whole. Flow separation is reduced while maintaining the necessary strength of the valve body in the direction of the opening. The recess thus reduces flow resistance.

This solution is particularly advantageous in the inflow region, i.e. the inlet region of the valve.

In order to avoid having to specify a preferred direction, which simplifies installation and operation, in one example the construction is mirror-symmetrical, i.e. symmetrical to an imaginary plane through the contour of the valve seat.

In one example, the valve body comprises at least one valve chamber that connects the at least one process fluid channel to the valve seat in a fluid-conducting manner and extends along an imaginary second central longitudinal axis, wherein the recess extends along an imaginary third central longitudinal axis, wherein a first obtuse angle enclosed by the third central longitudinal axis and the first and/or second central longitudinal axis is greater than a second obtuse angle enclosed by the first and second central longitudinal axes.

In one example, a central portion of the recess and a central portion of the valve seat are arranged spaced apart from one another along the imaginary first central longitudinal axis.

In one example, the central portion of the recess in an imaginary vertical plane of the third central longitudinal axis is less curved than an adjacent inner surface of the associated process fluid channel in an imaginary further vertical plane of the first central longitudinal axis.

The reduced degree of curvature of the central portion of the recess improves the flow behavior from the process fluid channel in the direction of the diaphragm and valve seat.

In one example, the central portion of the recess in the imaginary vertical plane of the third central longitudinal axis is less curved than the central portion of the valve seat in an imaginary further vertical plane of the first central longitudinal axis.

The deep valve seat advantageously increases the possible flow rate, whereas the less curved central portion of the recess improves the flow transition to the diaphragm.

In one example, the central portion of the recess perpendicular to the first central longitudinal axis is at least half as large, in particular at least two-thirds as large, as the diameter of the associated process fluid channel.

This advantageously improves the flow characteristics of the valve body, since the central portion dimensioned in this way provides an enlarged effective cross section in the direction of the valve seat.

In one example, the valve seat comprises a seating surface running along its contour, wherein at least one transition region between the seating surface and an inner surface of the valve chambers has a faceting, at least in portions.

This advantageously further improves the kV value of the valve.

In one example, the valve body is made of a metal alloy.

Advantageously, the faceting in the region of the valve seat and/or the recess is produced by an automated milling process, which improves the manufacturing quality of the individual valve bodies as manufacturing-related differences between individual specimens are reduced.

A second aspect of the description relates to a valve body for a diaphragm valve, the valve body comprising: at least two process fluid connections; at least two process fluid channels, each of which connects a process fluid connection to an associated valve chamber in a fluid-conducting manner; the two valve chambers; and a valve seat arranged between the two valve chambers, which is accessible via an opening in the valve body that can be closed by means of a valve diaphragm, wherein the valve seat follows a linear contour that extends from one side of the opening to the opposite side of the opening, wherein the valve seat comprises a seating surface running along the contour, and wherein at least one transition region between the seating surface and a surface of one of the valve chambers has a particular faceting, at least in portions.

The faceting of the transition between the central seating surface and the surfaces of the valve chambers results in improved flow characteristics when the valve is open, as the faceting reduces flow separation in the fluid.

In one example, the faceting has a plurality of chamfers, at least in portions.

This multi-surface faceting advantageously provides a convex curvature of the seating region, which improves the kV value, i.e. the flow properties of the valve body.

In one example, in a longitudinal section along a central longitudinal axis of one of the process fluid channels, an obtuse angle between the seating surface and the adjacent chamfer is greater than an obtuse angle between the surface of the valve chamber and the adjacent chamfer.

This advantageously creates a transition region that, starting from the seating surface, initially slopes rather gently and then more steeply toward the valve chambers. In this way, the scaling function of the seat can be maintained and at the same time the kV value can be improved.

In one example, the at least one transition region parallel to the central longitudinal axis of one of the process fluid channels is dimensioned larger than the seating surface.

Advantageously, the entire seating region thus follows a relatively large curvature. Nevertheless, the web-like seating surface forms a sealing counter-bearing to the valve diaphragm.

In one example, the valve body comprises at least one recess arranged between the opening and one of the process fluid channels, which recess extends along an imaginary third central longitudinal axis, wherein a first obtuse angle enclosed by the third central longitudinal axis and a first central longitudinal axis of the process fluid channel and/or by the third central longitudinal axis and a second central longitudinal axis of a valve chamber is greater than a second obtuse angle enclosed by the first and the second central longitudinal axes.

The recess further improves the kV value of the valve body.

In one example, the valve body is made of a metal alloy.

Advantageously, the faceting in the region of the valve seat and/or the recess is produced by a milling process.

A third aspect of the description relates to a diaphragm valve comprising the valve body according to the first or second aspect. The valve body also comprises the valve diaphragm, which closes the opening of the valve body; a drive rod coupled to the valve diaphragm; and a drive coupled to the drive rod for its movement along an adjusting axis.

Further details and embodiments of the disclosure can be found in the following description, by which embodiments of the disclosure are further described and explained.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 shows a valve body for a diaphragm valve in a longitudinal section;

FIG. 2 is a perspective view of the valve body;

FIG. 3 shows a valve seat of the valve body in a longitudinal section;

FIG. 4 shows a recess of the valve body in a longitudinal section; and

FIG. 5 shows a diaphragm valve with an exemplary flow.

### DETAILED DESCRIPTION

The valve body described herein is engineered to overcome the flow inefficiencies and contamination risks associated with conventional diaphragm valves. This is achieved by reconfiguring the valve's internal flow geometry to improve continuity between the process fluid channel, valve chamber, and valve seat. Features such as the angled recess, faceted transitions, and aligned longitudinal axes improve the uniformity of flow paths, reduce flow turbulence, and enable a cleaner, more efficient valve cavity while maintaining scaling reliability and manufacturability.

As used herein, the term “recess” refers to a fluid-conducting indentation or channel between the valve opening and a fluid channel that influences flow behavior.

As used herein, the term “central portion” refers to the middle segment of a geometrical region (such as a recess or valve seat) aligned with the central longitudinal axis.

As used herein, the term “faceting” refers to a contoured or chamfered surface geometry that transitions between surfaces to reduce flow separation.

As used herein, the term “kV value” denotes the flow coefficient representing the valve's flow capacity and efficiency.

As used herein, the term “seating surface” refers to the surface of the valve seat that interfaces with the valve diaphragm in the closed position to provide a seal. The seating surface typically follows the contour of the valve seat and may include convex or concave segments to conform to diaphragm geometry.

As used herein, the term “transition region” refers to a surface segment that connects two adjacent surfaces, such as between the seating surface and a valve chamber wall. A transition region may include faceting, chamfers, radiused edges, or other geometry that modifies flow between surfaces.

As used herein, the term “chamfer” refers to a flat or angled surface that replaces a sharp edge between two adjoining surfaces. A chamfer may be planar or curved, and a plurality of chamfers may be used to approximate a faceted or arcuate transition.

As used herein, the term “linear contour” refers to a generally straight or smoothly curved profile extending from one side of the valve seat to the opposite side, as viewed in a cross-sectional plane perpendicular to the diaphragm plane. It may include segments of constant curvature or facets aligned in a linear arrangement.

As used herein, the term “valve chamber” refers to a fluid-conducting region of the valve body that extends between the process fluid channel and the valve seat. The valve chamber guides flow into or out of the area adjacent the valve diaphragm and may include one or more recesses or transitional surfaces.

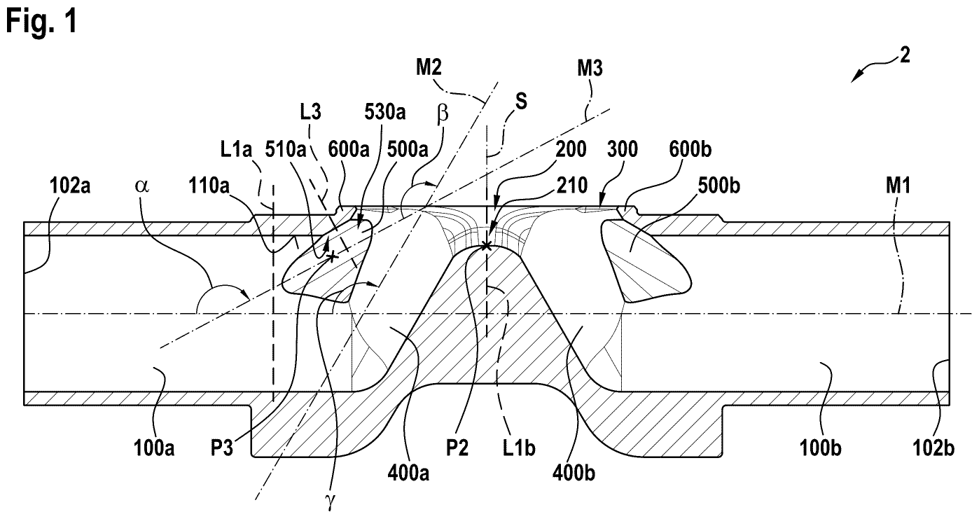

FIG. 1 shows a valve body 2 for a diaphragm valve in a schematic longitudinal section. The valve body 2 is made of a metal alloy. The valve body 2 comprises two process fluid channels 100a-b, which extend along an imaginary common first central longitudinal axis M1. Of course, in examples not shown, the central longitudinal axes of the various process fluid channels may also diverge. In particular in valve blocks, the process fluid channels can deviate from the longitudinal shape and, for example, be curved in portions.

A valve seat 200 is accessible via an opening 300 in the valve body 2. The opening 300 can be closed by means of a valve diaphragm and is closed during operation of the diaphragm valve.

The diaphragm valve is closed when the valve diaphragm is pressed onto the valve seat 200. The diaphragm valve is opened when the valve diaphragm is lifted from the valve seat 200.

A particular valve chamber 400a-b connects the associated process fluid channel 100a-b to the valve seat 200 in a fluid-conducting manner. The particular valve chamber 400a-b extends along an imaginary second central longitudinal axis M2. The two process fluid channels 100a-b each connect a process fluid connection 102a-b to an associated valve chamber 400a-b in a fluid-conducting manner.

A recess 500a-b is arranged between the opening 300 and the particular process fluid channel 100a-b. The particular recess 500a-b extends along an imaginary third central longitudinal axis M3.

The recess 500a-b delimits the interior space opposite the valve seat. “Opposite” means in particular that the interior space, which is delimited together with the valve diaphragm during operation, is delimited on one side in portions by the recess 500a-b and on an opposite side by the valve seat 200.

The recess 500a-b is associated with the valve chamber 400a-b, thus forming part of it.

The recess 500a-b defines a flow space located opposite the valve seat 200, delimiting the interior of the valve body 2 in a region that, together with the valve diaphragm 6, forms a flow chamber when the diaphragm valve 4 is open. The recess 500a-b connects the associated process fluid channel 100a-b to the valve chamber 400a-b in a fluid-conducting manner.

FIG. 1 illustrates the construction of the recess 500a by way of example. In the description, reference is made to the indices a and b, since the valve body 2 is constructed mirror-symmetrically to an imaginary plane through the valve seat 200. Of course, asymmetric designs of the valve body 2 are also conceivable.

A first obtuse angle α, β, which is enclosed by the third central longitudinal axis M3 and the first and/or second central longitudinal axis M1, M2, is greater than a second obtuse angle γ, which is enclosed by the first and second central longitudinal axes M1, M2.

In the example, the first obtuse angle α is 152° and β is 148°. The second obtuse angle γ is 120°.

In an example not shown, ß is 160°. The second obtuse angle γ is 130° in the example not shown.

The ratio of the obtuse angle γ to the obtuse angle ß is between 0.7 and 0.9, in particular between 0.75 and 0.85.

The ratio of the obtuse angle γ to the obtuse angle α is between 0.7 and 0.9, in particular between 0.75 and 0.85.

The entire valve chamber 400a-b thus extends along the second central longitudinal axis M2, wherein the central longitudinal axis M2 is steeper with respect to the longitudinal axis of the process fluid channel M1 than the central longitudinal axis M3 of the recess 500a-b.

With respect to the adjusting axis S, the central longitudinal axis M2 of the entire valve chamber 400a-b is flatter than the central longitudinal axis M3 of the recess 300a-b.

The longitudinal section in FIG. 1 shows that the recess 500a-b is arranged opposite the wall of the valve chamber 400a-b, which runs towards the valve seat 200.

The adjusting axis S and the longitudinal axis M1 span a common imaginary plane, the drawing plane in FIG. 1, in which the central longitudinal axis M2 of the recess 500a-b lies. A central portion 510a of the recess 500a and a central portion 210 of the valve seat 200 are arranged spaced apart from one another along the imaginary first central longitudinal axis M1.

An imaginary center point P3 of the central portion 510a-b of the recess 500a-b lying on the central longitudinal axis M2 and an imaginary center point P2 of the central section 210 of the valve seat 200 lie in a common imaginary plane in which the imaginary central longitudinal axis M1 lies.

In other words, the central portion 510a of the recess 500a and the central portion 210 of the valve seat 200 are arranged relative to one another along the imaginary first central longitudinal axis M1 in a non-rotated manner. Rather, the central portions 510a and 210 are aligned with one another in a fixed orientation. In particular, surfaces of the central portions 510a and 210 face one another at least in portions, which means that the associated normal vectors point in opposite directions, albeit at an angle to one another.

The central portion 510 of the recess 500a-b in an imaginary vertical plane L3 of the third central longitudinal axis M3 is less curved than an adjacent inner surface 110 of the associated process fluid channel 100 in an imaginary further vertical plane L1a of the first central longitudinal axis M1.

The central portion 510 of the recess 500a-b in the imaginary vertical plane L3 of the third central longitudinal axis M3 is less curved than the central portion 210 of the valve seat 200 in an imaginary further vertical plane L1b of the first central longitudinal axis M1.

The faceting of the recess 500a-b runs in an arcuate manner in the vertical plane L3.

In this description, the curvature of a line is understood as a measure by which the line deviates from a straight line. The curvature at a point on the line is defined as the reciprocal of the radius of curvature at that point. It indicates how curved the line is at this point.

A stronger curvature occurs when the radius of curvature is small, which means that the line or contour is strongly curved. In contrast, a weaker curvature has a larger radius of curvature, indicating that the line or contour is less curved and closer to a straight line.

In practice, the curvature of a line or contour can be determined using various mathematical and geometric methods, including calculating the radius of curvature or applying differential geometry.

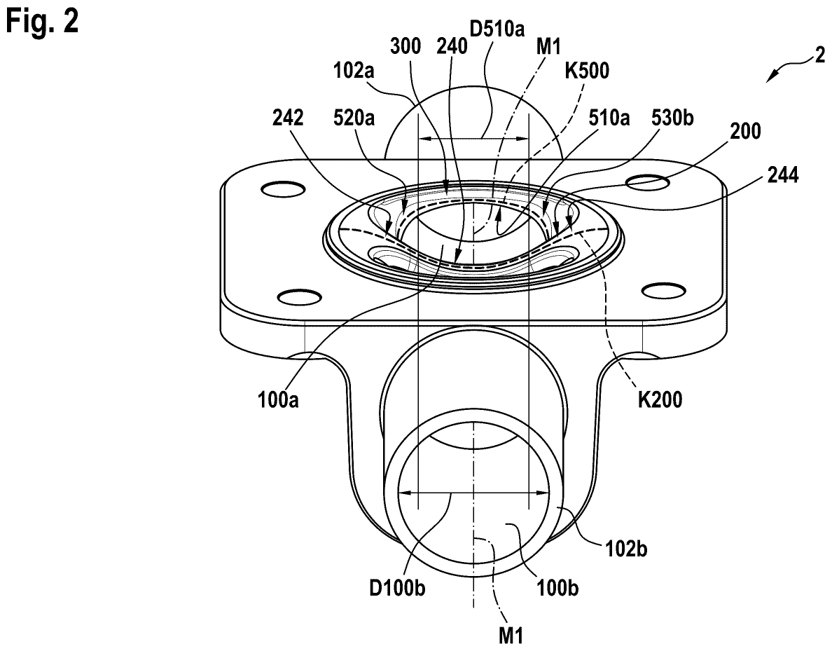

FIG. 2 is a perspective top view of the valve body 2, looking into the process fluid channel 100a via the opening 300, which is closed by the valve diaphragm during operation.

It is provided that the central portion 510a-b of the recess 500a-b perpendicular to the first central longitudinal axis M1 with its width D510a-b is at least half as large, in particular at least two-thirds as large, as the diameter D100a-b of the associated process fluid channel 100a-b.

For clarity, FIG. 2 shows a comparison of the width D510a of the central portion 510a. However, since the valve body 2 shown is constructed symmetrically to a plane through the valve seat 200, this comparison shown is possible.

The lateral portions 520a, 530a surrounding the central portion 510a have a greater curvature perpendicular to the third central longitudinal axis M3 than the inner wall 110a of the associated process fluid channel 100a in the vertical plane L1a of the first central longitudinal axis M1.

The central portion 510a-b is a central chamfer of the recess 500a-b. The lateral portions 520a-b and 530a-b are lateral chamfers of the central portion 510a-b that adjoin the central chamfer.

The ratio of the width D510a of the central portion 510a to the diameter D100a-b of the associated process fluid channel 100a-b is between 0.5 and 0.9, in particular between 0.6 and 0.8, in particular between 0.65 and 0.75.

The recess 500a-b follows a central contour K500, which extends from one side of the associated chamber 400a-b to the other side. In the region of the central portion 510a-b, the recess 500a-b is less curved than the central portion 210 of the valve seat 200.

The valve seat 200 follows a linear contour K200 that extends from one side of the opening 300 to the opposite side of the opening 300. The valve seat 200 comprises the seating surface 202 running along the contour K200.

The course of the seating surface 202, i.e. the contour K200, and the adjusting axis lie in a common plane.

A central portion 240 of the valve seat 200, which is concavely shaped along the contour K200 of the valve seat 200, is arranged between portions 242, 244 of the valve seat 200, which are convexly shaped along the contour K200.

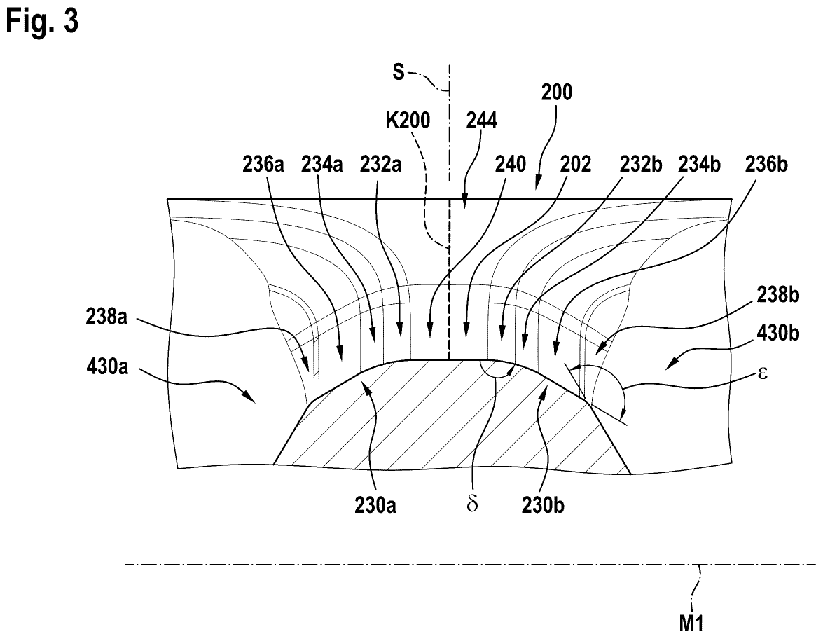

FIG. 3 shows a section of the valve seat 200 from FIG. 1. The valve seat 200 comprises a seating surface 202 running along its contour K200. The transition regions 230a-b between the seating surface 202 and a particular inner surface 430a-b of the valve chambers 400a-b have a faceting, at least in portions.

The faceting of the particular transition region 230a-b comprises, at least in portions, a plurality of chamfers 232a-b, 234a-b, 236a-b, 238a-b.

In a longitudinal section along a central longitudinal axis M1 of one of the process fluid channels 100a-b, an obtuse angle δ between the seating surface 202 and the adjacent chamfer 232a-b is greater than an obtuse angle ε between the inner surface 430a-b of the valve chamber 400 and the adjacent chamfer 238a-b.

The particular transition region 230a-b is parallel to the central longitudinal axis M1 of one of the process fluid channels 100a-b in FIG. 1 and is dimensioned larger than the seating surface 202.

The seating surface 202 is arranged in a longitudinal section of the valve body between two faceted transition regions 230a-b. In addition, the seating surface 200 parallel to the central longitudinal axis M1 of the process fluid channels 100a-b is dimensioned smaller than a particular one of the transition regions 230a-b parallel to the central longitudinal axis M1.

The faceting of the valve seat 200 or the transition region 230a-b runs in an arcuate manner in an imaginary plane in which the adjusting axis S and the central longitudinal axis M1 lie. This imaginary plane coincides with the drawing plane of FIG. 3.

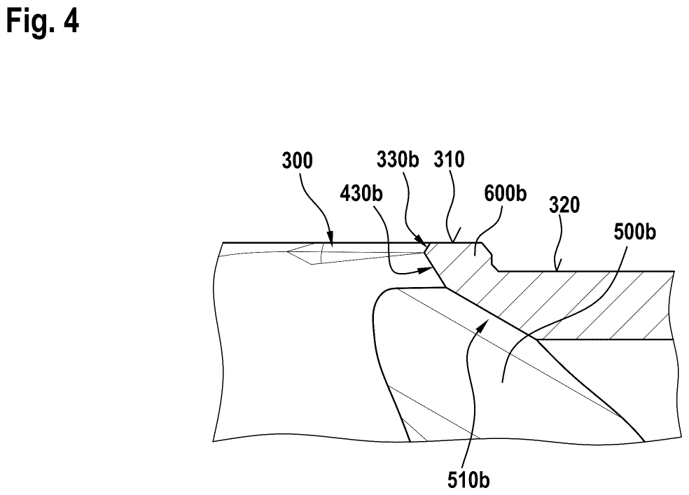

FIG. 4 shows, in a longitudinal section analogous to FIG. 1, the region of the opening 300 that transitions into the recess 500b. The opening 300 is surrounded by a clamping surface 310, which extends annularly around the opening 300 and is raised relative to a lateral clamping surface 320. The outer clamping surface 320 surrounds the inner clamping surface 310. The valve diaphragm rests against the clamping surfaces 310 and 320 during operation.

A faceted transition 330a-b is arranged between the opening 300 and the inner surface 430b. The faceted transition 330a-b with a plurality of chamfers extends in portions in the circumferential direction of the opening 300 in a region associated with the recess 500a-b.

A projection 600a-b, which comprises the clamping surface 310, extends in the longitudinal section of the valve body 2 from a main body of the valve body 2 in the direction of the opening 300.

The central portion 510a-b adjoins the inner surface 430a-b starting from the opening 300 in the direction of the associated process fluid channel 100a-b.

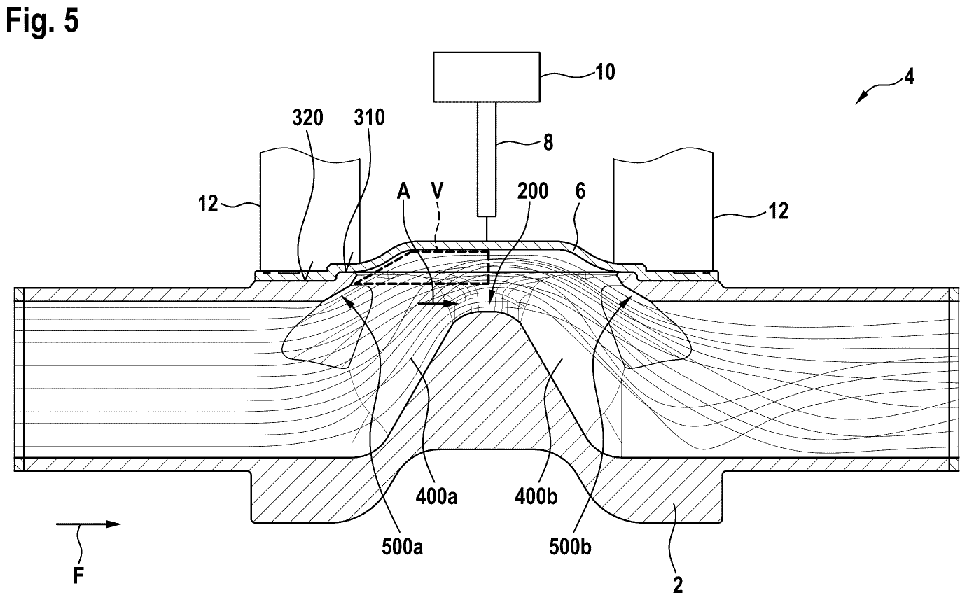

FIG. 5 shows the diaphragm valve 4 in a longitudinal section analogous to FIG. 1, whereby, in contrast to FIG. 1, the components of the diaphragm valve 4 are shown schematically and the flow conditions of the optimized valve body 2 are also shown.

The valve diaphragm 6 closes the opening 300 of the valve body 2. A drive rod 8 coupled to the valve diaphragm 6 is moved by a drive 10.

The lateral portion of the valve diaphragm 6 is pressed by means of a clamping body 12 onto a clamping portion of the valve body 2 surrounding the opening 300 according to the clamping surfaces 310 and 320.

The drive 8, which is designed, for example, as a pneumatic drive, magnetic drive or electric drive, is supported on the valve body 2 in order to lift the drive rod 8 along the actuating axis and thus the valve diaphragm 6 from the valve seat 200 or to press it onto the valve seat 200.

FIG. 5 schematically shows the flow behavior generated by the valve body 2. The process fluid flowing into the valve body 2 in the flow direction F can penetrate through the recess 500 more easily and without significant flow separation into the region V, which is delimited by the valve diaphragm 6 in the open state.

The faceted valve seat 200 improves the flow behavior in an inflow region A of the valve seat 200 by preventing sharp deflections of the process fluid. Nevertheless, a secure seal in the region of the valve seat 200 is ensured.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure. Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve body for a diaphragm valve, the valve body comprising:
a process fluid channel extending along a first central longitudinal axis;
a valve seat accessible via an opening of the valve body that is configured to be closed by a valve diaphragm; and
a recess arranged between the opening and the process fluid channel.

2. The valve body of claim 1, further comprising:
a valve chamber that connects the process fluid channel to the valve seat in a fluid-conducting manner, the valve chamber extending along a second central longitudinal axis,
wherein the recess extends along a third central longitudinal axis, and
wherein an obtuse angle between the third central longitudinal axis and the first or second central longitudinal axis is greater than an obtuse angle between the first and second central longitudinal axes.

3. The valve body of claim 1, wherein the recess is aligned with a central longitudinal axis of a valve chamber lying in a plane defined by the first central longitudinal axis and an adjusting axis.

4. The valve body of claim 1, wherein a central portion of the recess and a central portion of the valve seat are spaced apart along the first central longitudinal axis.

5. The valve body of claim 1, wherein a central portion of the recess and a central portion of the valve seat are spaced apart along the first central longitudinal axis.

6. The valve body of claim 4, wherein the central portion of the recess in the vertical plane of the third central longitudinal axis is less curved than the central portion of the valve seat in a corresponding vertical plane of the first central longitudinal axis.

7. The valve body of claim 4, wherein the central portion of the recess, measured perpendicular to the first central longitudinal axis, is at least half as large as a diameter of the process fluid channel.

8. The valve body of claim 1, wherein the valve seat includes a seating surface, and wherein a transition region between the seating surface and an inner surface of a valve chamber includes a faceted geometry.

9. The valve body of claim 1, wherein the valve seat includes a seating surface, and wherein a transition region between the seating surface and an inner surface of a valve chamber includes a faceted geometry.

10. A valve body for a diaphragm valve, the valve body comprising:
two process fluid connections;
two process fluid channels, each configured to connect a respective process fluid connection to an associated valve chamber in a fluid-conducting manner;
two valve chambers; and
a valve seat arranged between the valve chambers, the valve seat being accessible via an opening of the valve body and configured to be closed by a valve diaphragm;
wherein the valve seat follows a linear contour that extends from one side of the opening to an opposite side of the opening;
wherein the valve seat includes a seating surface extending along the linear contour; and
wherein a transition region between the seating surface and a surface of one of the valve chambers includes a faceted geometry.

11. The valve body of claim 10, wherein the faceted geometry includes a plurality of chamfers.

12. The valve body of claim 10, wherein, in a longitudinal section along a central longitudinal axis of one of the process fluid channels, an obtuse angle between the seating surface and an adjacent chamfer is greater than an obtuse angle between the surface of the valve chamber and an adjacent chamfer.

13. The valve body of claim 10, wherein the transition region parallel to the central longitudinal axis of one of the process fluid channels is dimensioned larger than the seating surface.

14. The valve body of claim 10, wherein the transition region parallel to the central longitudinal axis of one of the process fluid channels is dimensioned larger than the seating surface.

15. A diaphragm valve comprising:
a valve body according to claim 1;
a valve diaphragm configured to close the opening of the valve body;
a drive rod coupled to the valve diaphragm; and
a drive mechanism coupled to the drive rod and configured to move the drive rod along an adjusting axis.
